(19) United States
(12) Patent Application Publication
(10) Pub. No.: US 2025/0393034 A1
(43) Pub. Date: Dec. 25, 2025

(54) SLOT LEVEL EXCLUSION/RESOURCE SELECTION

(71) Applicant: QUALCOMM Incorporated, San Diego, CA (US)

(72) Inventors: Tien Viet NGUYEN, Bridgewater, NJ (US); Shuanshuan WU, San Diego, CA (US); Kapil GULATI, Belle Mead, NJ (US); Gabi SARKIS, San Diego, CA (US); Sourjya DUTTA, Jersey City, NJ (US); Hui GUO, Beijing (CN)

(21) Appl. No.: 19/160,828

(22) PCT Filed: Apr. 13, 2023
(86) PCT No.: PCT/CN2023/087981

§ 371 Date: Aug. 28, 2025

(51) Int. Cl. H04W 72/0446; H04W 72/25

(52) U.S. Cl. CPC H04W 72/0446; H04W 72/25

(57) ABSTRACT

A method for wireless communication at an interfered user equipment (UE) and related apparatus are provided. In the method, the interfered UE receives sidelink control information (SCI) from an interfering UE. The SCI may indicate a sidelink transmission in a resource of a first slot. The interfered UE further excludes the first slot from a candidate set of resources in response to receiving the SCI indicating the sidelink transmission in the resource of the first slot, and monitors the sidelink transmission from the interfering UE in the resource of the first slot. The method enables the interfered UE to manage the transmission resource for a sidelink transmission on the slot level based on various characteristics of the sidelink transmission. The method reduces the inter-UE interference and improves the efficiency of wireless communication.

### TECHNICAL FIELD

The present disclosure relates generally to communication systems, and more particularly, to resource selection for sidelink communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include one or more memories and at least one processor coupled to the one or more memories. Based at least in part on information stored in the one or more memories, the at least one processor may be configured to receive sidelink control information (SCI) from a first UE, the SCI indicative of a sidelink transmission in a resource of a first slot; exclude the first slot from a candidate set of resources in response to receiving the SCI indicating the sidelink transmission in the resource of the first slot; and monitor the sidelink transmission from the first UE in the resource of the first slot.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a first device and a second device involved in wireless communication.

FIG. 4 is a diagram illustrating example aspects of a sidelink slot structure.

FIG. 5 is a diagram illustrating an example of sidelink communication between devices.

FIG. 6A is a diagram illustrating an example of time and frequency resources showing reservations for sidelink transmissions.

FIG. 6B is a diagram illustrating an example of semi-periodic scheduling (SPS) reservations for sidelink transmissions.

FIG. 7 is a diagram illustrating an example timeline for a sensing-based resource selection.

FIG. 8 is a diagram illustrating an example inter-UE coordination for sidelink communication.

FIG. 9 is a diagram illustrating an example of resource selection and exclusion for sidelink communication in accordance with various aspects of the present disclosure.

FIG. 10 is a diagram illustrating an example of resource selection and exclusion for sidelink communication in accordance with various aspects of the present disclosure.

FIG. 11 is a call flow diagram illustrating a method of wireless communication in accordance with various aspects of the present disclosure.

FIG. 12 is a flowchart illustrating methods of wireless communication at a UE in accordance with various aspects of the present disclosure.

FIG. 13 is a diagram illustrating an example of a hardware implementation for an example apparatus and/or UE.

### DETAILED DESCRIPTION

Sidelink communication between UEs may cause interference with each other. The interference may be related to various factors, such as the distances between the UEs and the transmission resources used. The UEs may be coordinated, in terms of, for example, the transmission resources and transmission times to reduce interference.

Various aspects relate generally to communication systems. Some aspects more specifically relate to slot level resource exclusion and resource selection for sidelink communication. In some examples, an interfered UE may receive SCI from a first UE, the SCI indicative of a sidelink transmission in a resource of a first slot; exclude the first slot from a candidate set of resources in response to receiving the SCI indicating the sidelink transmission in the resource of the first slot; and monitor the sidelink transmission from the first UE in the resource of the first slot. In some aspects, the exclusion of the first slot from a candidate set of resources may be based on a distance threshold or a reference signal received power (RSRP) threshold, which may be related to the congestion level of the channel.

Particular aspects of the subject matter described in this disclosure can be implemented to realize one or more of the following potential advantages. In some examples, by receiving SCI from a first UE; and excluding the resources from a candidate set of resources in response to receiving the SCI indicating the sidelink transmission in the resources, the described techniques can be used to reduce interference for sidelink communication by preventing, at a slot level, the resources scheduled for a sidelink transmission from being used by other transmissions. Additionally, the exclusion criteria may be related to the congestion level, the priority of the sidelink transmission, or the cast type of the sidelink transmission. Hence, the exclusion of resources may be adapted to the conditions of the channel or the characteristics of the transmission.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

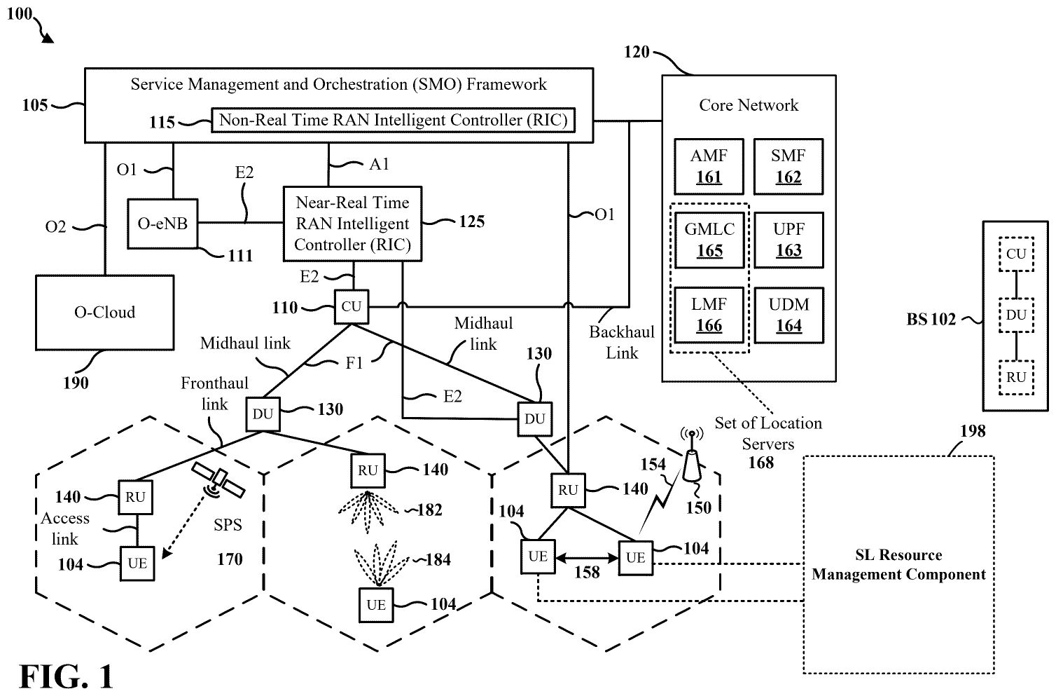

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Some UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

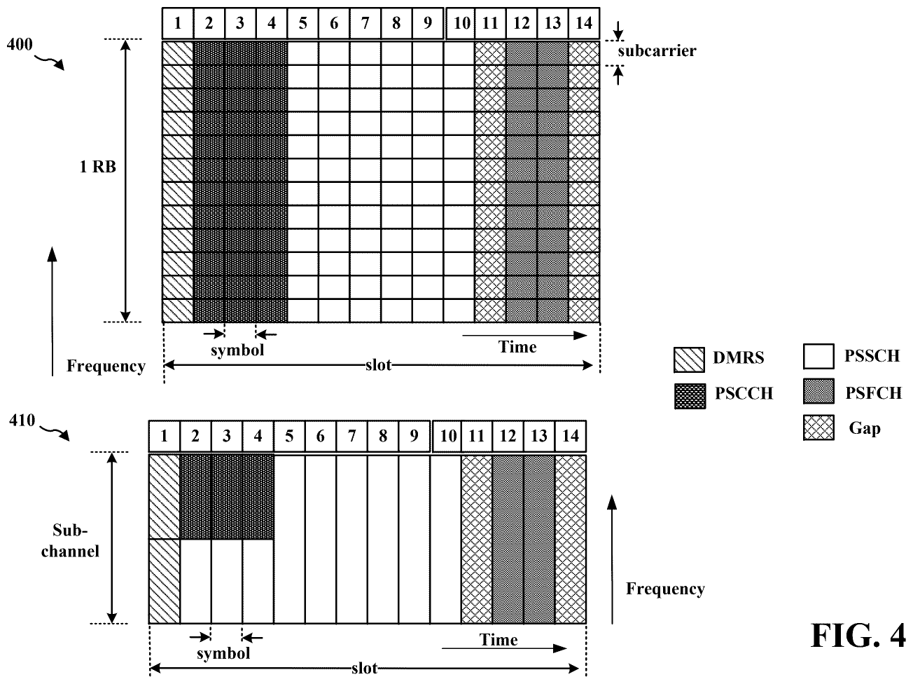

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU), etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

Referring again to FIG. 1, in certain aspects, the UE 104 may include a SL resource management component 198. The SL resource management component 198 may be configured to receive SCI from a first UE, the SCI indicative of a sidelink transmission in a resource of a first slot; exclude the first slot from a candidate set of resources in response to receiving the SCI indicating the sidelink transmission in the resource of the first slot; and monitor the sidelink transmission from the first UE in the resource of the first slot. Although the following description may be focused on 5G NR, the concepts described herein may be applicable to other similar areas, such as LTE, LTE-A, CDMA, GSM, and other wireless technologies.

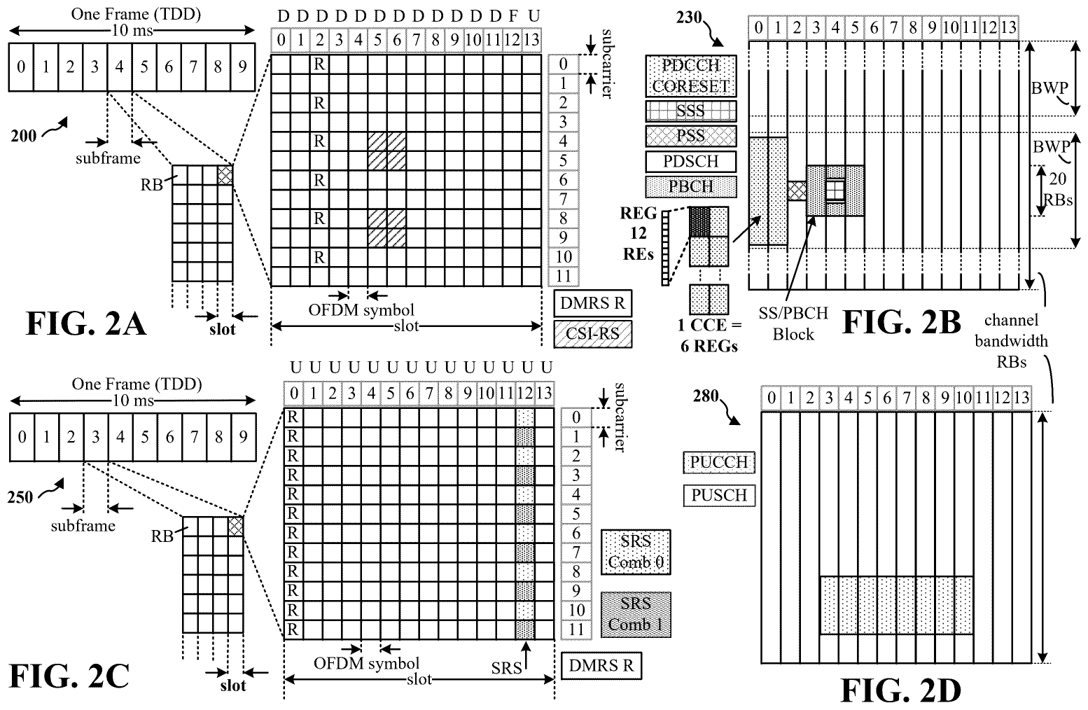

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

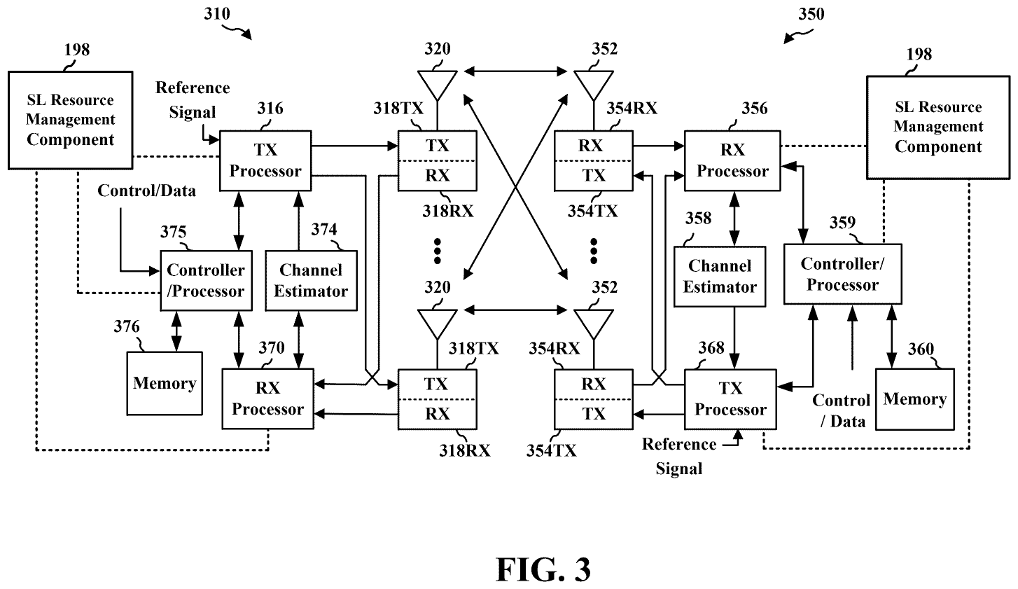

FIG. 3 is a block diagram of a first wireless communication device 310 in communication with a second wireless communication device 350. In some aspects, the communication may be based on sidelink. In some examples, the devices 310 and 350 may communicate based on V2X or other sidelink or D2D communication. The communication may be based on sidelink using a PC5 interface. The devices 310 and 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by device 350. Each spatial stream may then be provided to a different antenna 320 via a separate transmitter 318TX. Each transmitter 318TX may modulate an RF carrier with a respective spatial stream for transmission.

At device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for device 350. If multiple spatial streams are destined for device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at device 310 in a manner similar to that described in connection with the receiver function at device 350. Each receiver 318RX receives a signal through its respective antenna 320. Each receiver 318RX recovers information modulated onto an RF carrier and provides the information to an RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with the SL resource management component 198 of FIG. 1.

At least one of the TX processor 316, the RX processor 370, and the controller/processor 375 may be configured to perform aspects in connection with the SL resource management component 198 of FIG. 1.

FIG. 4 includes diagrams 400 and 410 illustrating example aspects of slot structures that may be used for sidelink communication (e.g., between UEs 104, RSU, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for a turnaround between the reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some aspects.

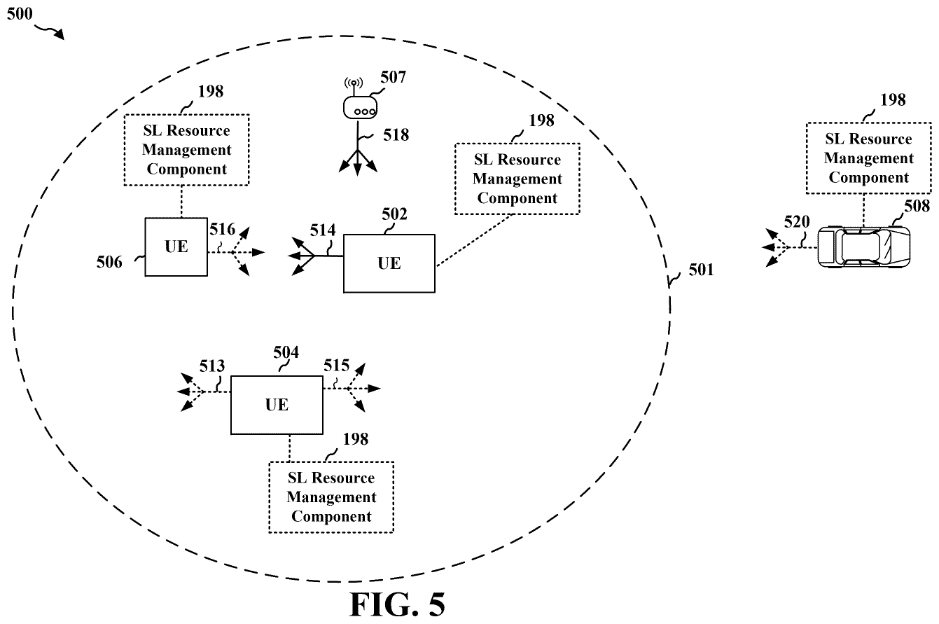

FIG. 5 illustrates an example 500 of sidelink communication between devices. The communication may be based on a slot structure including aspects described in connection with FIG. 4. For example, the UE 502 may transmit a sidelink transmission 514, e.g., including a control channel (e.g., PSCCH) and/or a corresponding data channel (e.g., PSSCH), that may be received by UEs 504, 506, 508. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 502, 504, 506, 508 may each be capable of sidelink transmission in addition to sidelink reception. Thus, UEs 504, 506, 508 are illustrated as transmitting sidelink transmissions 513, 515, 516, 520. The sidelink transmissions 513, 514, 515, 516, 520 may be unicast, broadcast or multicast to nearby devices. For example, UE 504 may transmit sidelink transmissions 513, 515 intended for receipt by other UEs within a range 501 of UE 504, and UE 506 may transmit sidelink transmission 516. Additionally, or alternatively, the RSU 507 may receive communication from and/or transmit communication 518 to UEs 502, 504, 506, 508. One or more of the UEs 502, 504, 506, 508 or the RSU 507 may include the SL resource management component 198 as described in connection with FIG. 1. FIG. 5 illustrates that at least one of the UEs may be associated with a vehicle, e.g., UE 508. In some aspects, the UEs may exchange V2X communication, for example.

Sidelink communication may be based on different types or modes of resource allocation mechanisms. In a first resource allocation mode (which may be referred to herein as “Mode 1”), centralized resource allocation may be provided by a network entity. For example, a base station 102 may determine resources for sidelink communication and may allocate resources to different UEs 104 to use for sidelink transmissions. In this first mode, a UE receives the allocation of sidelink resources from the base station 102. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

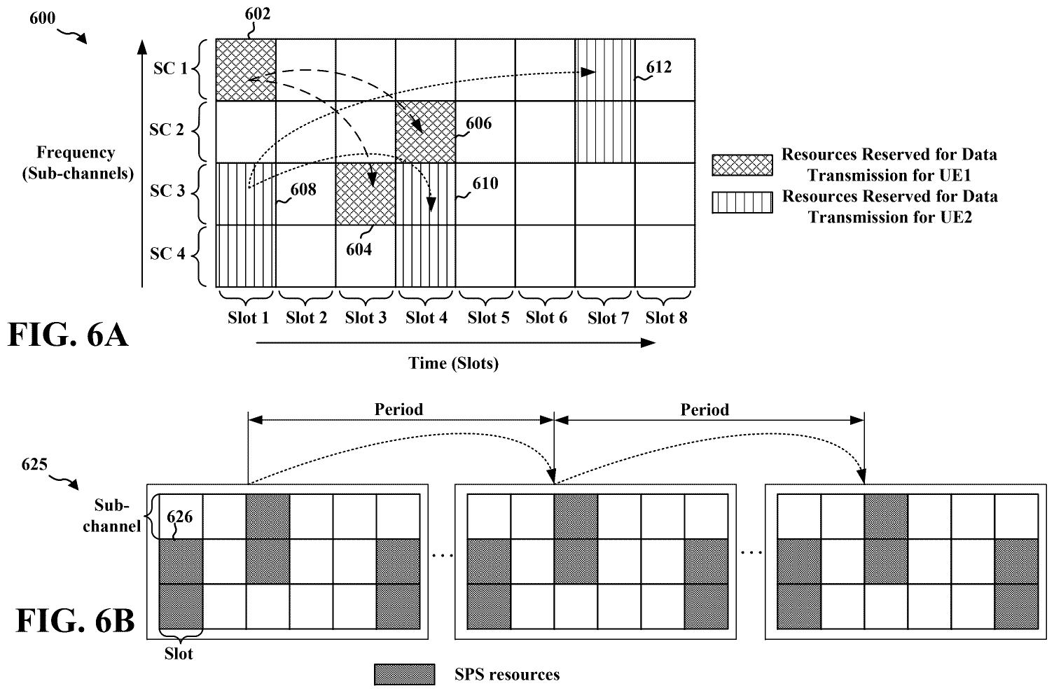

FIG. 6A is an example 600 of time and frequency resources showing reservations for sidelink transmissions. The resources may be included in a sidelink resource pool, for example. The resource allocation for each UE may be in units of one or more sub-channels in the frequency domain (e.g., sub-channels SC1 to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of pre-defined slots and sub-channels, such as an 8 time slots by 4 sub-channels window as shown in example 600, which provides 32 available resource blocks in total. This window may also be referred to as a resource selection window.

A first UE (“UE1”) may reserve a sub-channel (e.g., SC 1) in a current slot (e.g., slot 1) for its initial data transmission 602, and may reserve additional future slots within the window for data retransmissions (e.g., 604 and 606). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may do by including the reservation information in the reservation resource field of the SCI, e.g., a first stage SCI.

FIG. 6A illustrates that a second UE (“UE2”) reserves resources in sub-channels SC 3 and SC 4 at time slot 1 for its current data transmission 608, and reserves first data retransmission 610 at time slot 4 using sub-channels SC 3 and SC 4, and reserves second data retransmission 612 at time slot 7 using sub-channels SC 1 and SC 2 as shown by FIG. 6A. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 6A illustrates resources being reserved for an initial transmission and two retransmissions, the reservation may be for an initial transmission and a single transmission or only for an initial transmission.

FIG. 6B illustrates a time and resource diagram 625 showing an example in which the reservation 626 indicates an SPS reservation that repeats in a periodic manner for multiple periods.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resource set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 6A, the UE may transmit SCI reserving resources for data transmission 608, and data retransmissions 610 and 612.

In some examples, the RSRP threshold may be based on the amount of available resources. For example, if the amount of available resources is below a threshold (e.g., below 20%) within a selection window, the UE may use an increased RSRP threshold so that the UE is more likely to be able to reuse reserved resources. Similarly, the UE may decrease the RSRP when there is a larger amount of available resources, e.g., to minimize the chance of possible collision.

As an example, the UE may use an initial RSRP threshold

$${ρ}_{thresh}^{0} ,$$

which may be referred to herein as an initial resource exclusion RSRP threshold. If the measured RSRP for an SCI reserving resources is greater than

$${ρ}_{thresh}^{0} ,$$

the UE may remove the reserved resources from the candidate set that overlap with the reserved resources. The UE may perform a comparison to the initial resource exclusion RSRP threshold and removal of resources from the candidate set for resources reserved in multiple SCI received from one or more UEs. If the number of remaining resources in the candidate set is less than a threshold amount, e.g., a resource free criteria or resource free threshold x %, of the total number of resources, the UE may increase the resource exclusion RSRP threshold. For example, the UE may increment the RSRP threshold by a particular amount. In an example to illustrate the concept, the increment may be 3 dB, and the UE may increase the initial resource exclusion RSRP threshold

$${ρ}_{thresh}^{0}$$

by 3 dB, e.g.,

$${ρ}_{thresh}^{t} = {ρ}_{thresh}^{0} + 3 dB .$$

If the number of remaining resources in the candidate set is still below x % of the total resources, the UE may continue to increase the RSRP threshold, e.g.,

$${ρ}_{thresh}^{t + 1} = {ρ}_{thresh}^{t} + 3 dB$$

for t=0, 1, 2, 3 and so forth until the number of remaining resources in the candidate set meets or exceeds x % of the total resources. The increment amount of 3 dB is merely one example, and a different increment value may be used. The UE may stop at the RSRP threshold (e.g., which may be referred to as the resource exclusion threshold) at which the candidate set includes the threshold percentage of the total resources.

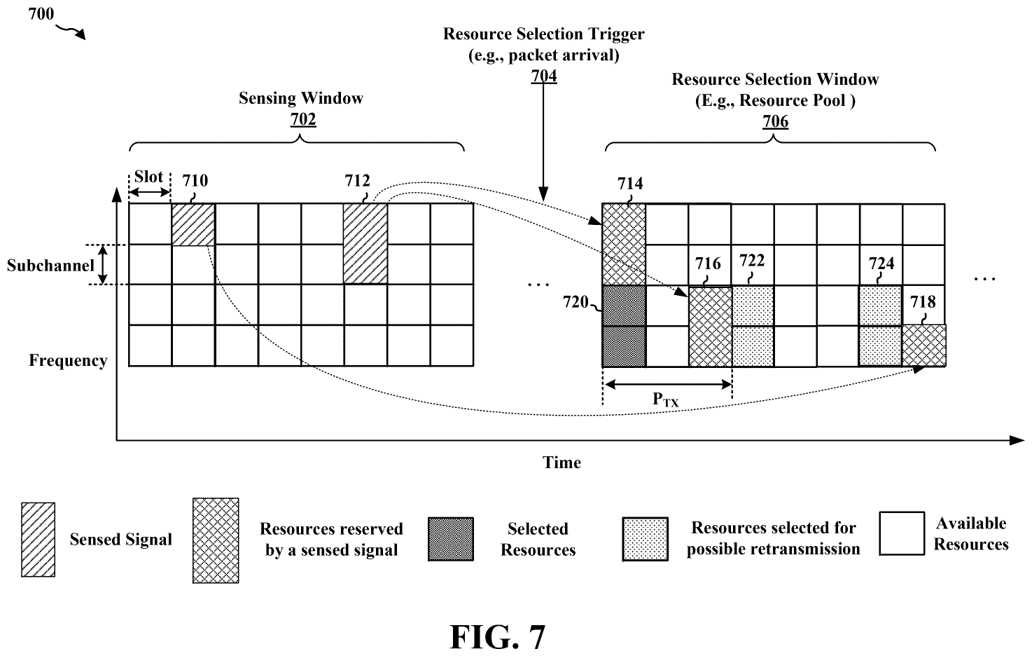

There may be a timeline for a sensing-based resource selection. For example, the UE may sense and decode the SCI received from other UEs during a sensing window 702, e.g., a time duration prior to resource selection. Based on the sensing history during the sensing window, the UE may be able to maintain a set of available candidate resources by excluding resources that are reserved by other UEs from the set of candidate resources. FIG. 7 is a diagram 700 illustrating an example timeline for a sensing-based resource selection. For example, in FIG. 7, the UE receives a reservation at 710 that reserves (e.g., indicates a transmission for) resources at 718, which the UE may exclude from a candidate resource set. FIG. 7 also illustrates that the UE receives a reservation, at 712, that reserves resources 714 and 716. The UE may exclude the resources 714 and 716 from a candidate resource set. When the UE has a transmission, the UE may select radio resources for the transmission from the set of candidate resources in a resource selection window 706, which is illustrated as an example having sixteen (32) resource blocks formed by four sub-channels and eight slots to illustrate the concept. The UE may be triggered, at 704, to select resources for a packet that has arrived for transmission. FIG. 7 illustrates that the UE selects the resources 720, which remain in the candidate resource set and resources 722 and 724 for potential retransmissions. After selecting the resources from its set of available candidate resources (e.g., the candidate resource set after excluding resources for which reservations were received), the UE transmits SCI reserving the selected resources for sidelink transmission (e.g., a PSSCH transmission) by the UE. There may be a time gap between the UE's selection of the resources and the UE transmitting SCI reserving the resources.

In wireless communication, multiple UEs may communicate and cooperate with each other to optimize their resource utilization, improve overall network performance, and reduce interference. This communication and cooperation among multiple UEs may be referred to as inter-UE coordination. Inter-UE coordination may take different forms depending on the network architecture and the specific application. For example, multiple UEs may transmit the same data simultaneously to improve the signal quality, to coordinate their transmissions to avoid interfering with each other, or to exchange information about their location and movement to facilitate the handover between cells.

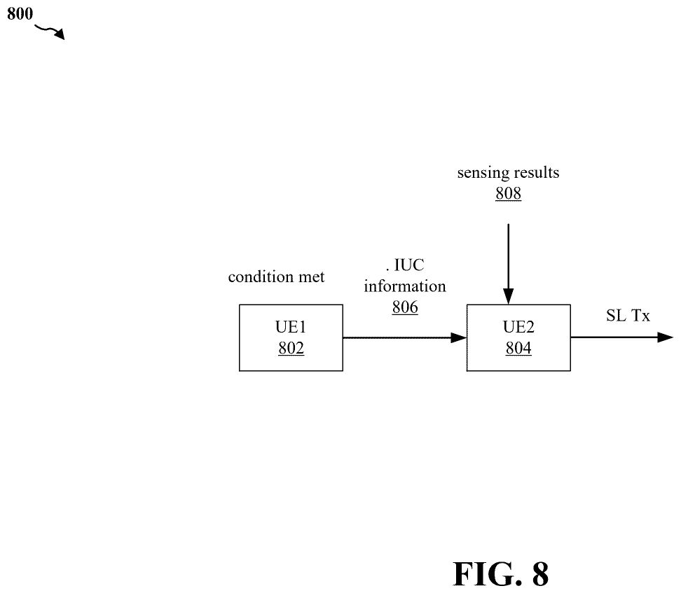

FIG. 8 is a diagram 800 illustrating an example of an inter-UE coordination (IUC) scheme. As shown in FIG. 8, a first UE (e.g., UE1 802) may first evaluate whether a condition to transmit IUC information without a request has been met. The condition may be determined by the UE and or may be configured for the UE. For example, the first UE (e.g., UE1 802) may transmit the IUC information to a second UE (e.g., UE2 804) when the first UE (e.g., UE1 802) has data to transmit with the IUC information. As shown in FIG. 8, when the condition (e.g., having data to transmit) is met, the first UE (e.g., UE1 802) may transmit the IUC information 806 to the second UE (e.g., UE2 804). The second UE (e.g., UE2 804) may select resources for sidelink transmission based on its available sensing results 808 and received IUC information 806. Then, the second UE (e.g., UE2 804) may perform sidelink transmission based on the selected resources.

In some examples, a resource may be considered non-preferred due to, for example, the interference it may cause if selected for transmission. For example, referring to the example of FIG. 8, to protect the first UE (e.g., UE1 802)'s reception of the second UE (e.g., UE2 804)'s transmission from strong interference by other UEs, a resource may be considered non-preferred if the resource has been reserved by other UEs and has a reference signal received power (RSRP) above a preconfigured threshold. In another example, to protect the first UE (e.g., UE1 802)'s transmission to other UEs from interference by the second UE (e.g., UE2 804), a resource may be non-preferred if the resource has been reserved by other UEs, is targeted to the first UE (e.g., UE1 802), and has an RSRP below a preconfigurable threshold. In yet another example, a resource may be considered non-preferred if the first UE (e.g., UE1 802) does not expect to perform reception from the second UE (e.g., UE2 804) on this resource due to half duplex. In some examples, a UE may reselect the resource for transmission if the originally selected resource is considered non-preferred.

Two UEs in sidelink communication with each other may avoid transmitting at the same time using the same frequency band to prevent collisions in half duplex. Additionally, even if the two UEs use different frequency bands to transmit at the same time (and hence do not result in the collision), the UEs may suffer interference from the spill-over radiation from the other frequency band, which may be referred to as the in-band emission (IBE). Hence, if a UE knows that it may receive in a slot, it may not transmit in that slot. By doing so, it avoids the IBE interference to nearly peer receivers.

Example aspects presented herein provide methods and apparatus for slot level resource exclusion and resource selection for sidelink communication.

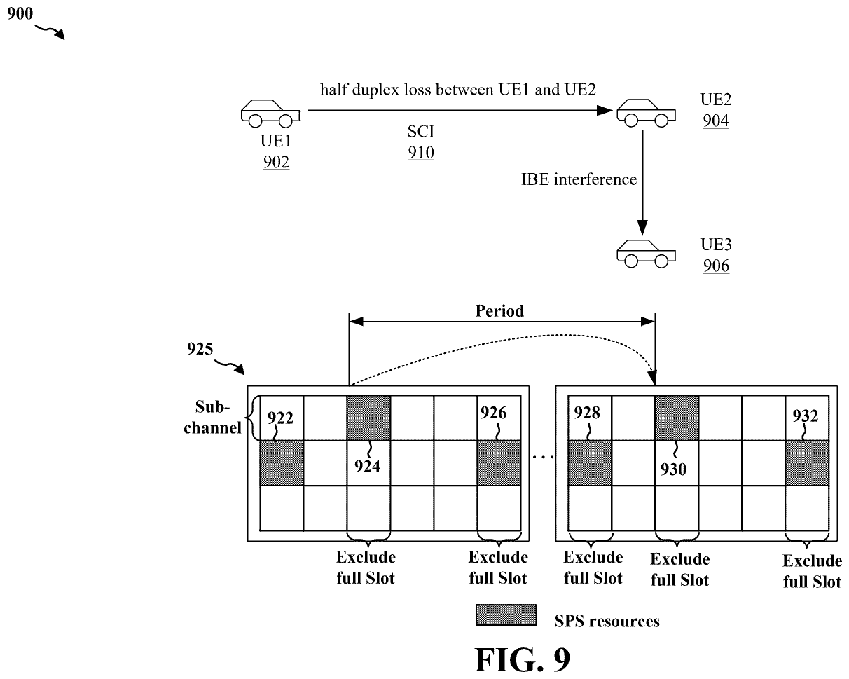

FIG. 9 is a diagram 900 illustrating an example of resource selection and exclusion for sidelink communication in accordance with various aspects of the present disclosure. Although FIG. 9 illustrates a UE associated with a vehicle setting, the aspects presented herein are not limited to vehicle settings and may be used by any UE performing sidelink communication. As shown in FIG. 9, the first UE (UE1 902) may transmit SCI 910 (e.g., SCI-1 and SCI-2) to the second UE (UE2 904). The SCI may indicate a sidelink transmission will occur in some slots. For example, the SCI may include a semi-persistent scheduling (SPS) periodicity, and, using the Reservation Periodicity (RSVP) information (e.g., the SPS periodicity P), the second UE (UE2 904) may expect similar sidelink transmission to arrive at slots n+P, n+2P, etc. Upon receiving the SCI, the second UE (UE2 904) may decode the SCI (e.g., SCI-2) and determine, based on the SCI (e.g., SCI-2), whether to accept or skip the sidelink communication at these slots (e.g., at slots n+P, n+2P). In some examples, even if the second UE (UE2 904) does not accept the sidelink communication, it may still avoid the slot if certain conditions (e.g., the RSRP and/or distance condition) are met. If the second UE (UE2 904) accepted the sidelink communication, it might avoid selecting resources at these slots (e.g., at slots n+P, n+2P) for other communication. If some resources in these slots (e.g., slots n+P, n+2P) have already been selected, the second UE (UE2 904) may reselect the resources that are not in these slots for communication. For example, FIG. 9 shows an example time and resource diagram 925, showing a resource 922 in which SCI may be received by the UE2 904 from the UE1 902 indicated an SPS reservation of resources for sidelink transmission at 924 and 928. As the indication is for an SPS, the UE2 904 may expect the same resources to be used, e.g., at 928, 930, 932. If the UE2 904 determines to accept either receive the sidelink communication from the UE1 902 and/or to exclude resources from a candidate resource set based on the reservation from UE1 902, the UE2 may exclude the full slot of candidate resources, e.g., exclude resources at the slot-level, rather than individual resources within the slot. For example, FIG. 9 shows that the UE may exclude the slot in which 924, 926, 928, 930, and 932 are to occur, even though they will only occupy one sub-channel of the slot.

The second UE (UE2 904) may determine whether to accept the sidelink transmission (and/or exclude a slot in which the transmission will occur from a candidate resource set) or skip the sidelink transmission (and/or retain the resources in a candidate resource set) based on various factors or criteria. In some aspects, the second UE (UE2 904) may decode the SCI (e.g., SCI-1 and SCI-2) at slot n and obtain at least one of the SPS periodicity, the zone information and the feedback distance and the layer 1 (L1) source and destination identifier (ID). The second UE (UE2 904) may measure the RSRP based on the SCI to obtain an RSRP measurement. The second UE (UE2 904) may first determine whether it is an intended recipient of the sidelink communication based on the L1 source and destination ID. Then, if the zone information and the feedback distance are available, the second UE (UE2 904) may determine whether to accept or skip the sidelink communication based on the zone information and the feedback distance D. In some examples, the second UE (UE2 904) may set a distance threshold T_{D}, and determine to receive the sidelink transmission if the distance (e.g., the distance between UE1 902 and UE2 904) is smaller than a smaller value of the feedback distant D or the distance threshold T_{D}. The distance threshold may be a threshold for slot level resource exclusion from a candidate resource set, for example. In some examples, even if the second UE (UE2 904) decides to skip the reception based on the L1 source and destination ID, it may still avoid the slot if the RSRP measurement is high or the distance is small to avoid creating emission to other receivers of the transmission.

In some aspects, the distance threshold T_{D} for slot level resource exclusion may be related to a congestion level for congestion control. In some examples, the congestion level may be measured by the channel busy ratio (CBR). In other examples, the congestion level may be based on the resource exclusion threshold used in mode 2 autonomous resource selection procedure, e.g., for non-slot level resource exclusion as discussed in connection with FIG. 6A and FIG. 6B. In one example, the congestion level may be represented by the CBR, and the distance threshold T_{D} may be a function with the CBR as the input. That is, T_{D}=f₁(CBR). In some examples, the distance threshold T_{D} may decrease as the CBR increases. Table 2 shows example distance thresholds T_{D} at different CBRs. In some examples, the CBR may be measured and averaged over a specific time frame, such as a time window larger than 100 ms. This approach facilities smoother measurement and helps prevent any negative impacts that may arise from irregular measurements (e.g., oscillating between different rows in the table).

TABLE 2
Example distance thresholds at different CBRs

| CBR | T_{D} |
|---|---|
| 10% | 1000 m |
| 40% | 300 m |
| 60% | 100 m |

In some aspects, the distance threshold T_{D} may be related to the priority of the sidelink transmission, which may be included in SCI-1. For example, the UE2 904 may apply a longer distance threshold T_{D} for a higher priority transmission than the distance threshold T_{D} for a lower priority transmission.

In some aspects, the distance threshold T_{D} may be related to the cast type of the sidelink transmission. The cast type may include unicast (communication between one transmitter and one receiver), groupcast or multicast (communication between one transmitter and a group of predetermined receivers) or broadcast (communication between one transmitter and all possible receivers within a transmission range). For example, the distance threshold T_{D} for unicast transmissions may be longer than the distance threshold T_{D} for groupcast or broadcast transmissions.

In some aspects, the zone information and the feedback distance may not be available to the second UE (UE2 904) (e.g., when the feedback distance is not used), e.g., may not be included in the SCI 910 from the UE1 902. In that case, the second UE (UE2 904) may measure the RSRP based on the SCI, and compare the RSRP measurement with an RSRP threshold T_{RSRP}. The second UE (UE2 904) may accept the sidelink transmission if the measured RSRP is higher than the RSRP threshold for slot level resource exclusion T_{RSRP}. In some examples, the RSRP threshold T_{RSRP} may be related to the congestion level for the purpose of congestion control. The congestion level may be measured by the CBR, in some aspects. In other aspects, the congestion level may be based on the non-slot level resource exclusion threshold used in mode 2 autonomous resource selection procedure, e.g., as described in connection with FIG. 6A and FIG. 6B. In one example, the congestion level may be measured by the CBR, and the RSRP threshold T_{RSRP} may be a function with the CBR as the input. That is, T_{RSRP}=f₂(CBR). In some examples, the RSRP threshold T_{RSRP} for slot level resource exclusion may increase as the CBR increases. Table 3 shows example RSRP thresholds T_{RSRP} at different CBRs.

In some aspects, the RSRP thresholds T_{RSRP} for slot level resource exclusion may be larger than the non-slot level resource selection RSRP threshold used in mode 2 autonomous resource selection procedure. In one example, the RSRP thresholds T_{RSRP} may be 6 dB larger than the resource selection RSRP threshold used in mode 2 autonomous resource selection procedure.

TABLE 3
Example RSRP thresholds at different CBRs

| CBR | T_{RSRP} | |
|---|---|---|
| 10% | −90 | dBm |
| 40% | −80 | dBm |
| 60% | 0 | dBm |

If the second UE (UE2 904) decides to accept the sidelink transmission, it may exclude the slots (e.g., slots n+P, n+2P) for the sidelink transmission in its resource selection or reselection procedures, e.g., exclude the slot(s) from a candidate resource set from which the UE selects its transmission resources. That is, these slots will not be selected or reselected by the second UE (UE2 904) for other transmissions. In some examples, even if the second UE (UE2 904) does not accept the sidelink communication, it may still exclude the slot (e.g., slots n+P, n+2P) if certain conditions (e.g., the RSRP and/or distance condition) are met. In some aspects, the exclusion of the slots (e.g., slot-level exclusion) may not apply to the slots of retransmission signaled, for example, in the SCI-1. As an example, the UE2 904 may exclude the full slot for a first transmission and may exclude at a resource level (such as a sub-channel level) within a slot for the retransmissions from a candidate resource set. In other aspects, the UE2 904 may exclude the full slot for the first transmission and may retain the resources of the retransmissions in its candidate resource set. For example, if the SCI-1 signals slot n for an initial transmission and slot m for the retransmission, with the SPS periodicity of P, the UE2 904 may exclude the slots at n+P, n+2P, etc., but may not exclude the slots at m+P, m+2P, etc.

In some aspects, the second UE (UE2 904) may have previously selected transmission resources in the to-be-excluded slots (e.g., slots n+P, n+2P). In that case, the second UE (UE2 904) may discard the resources it previously selected in the to-be-excluded slots and reselect different resources for its transmission.

In some aspects, the UEs may use different carriers in a carrier aggregation (CA) configuration or different resource pools for the sidelink communication, and the resource reservation in one carrier or one resource pool may exclude the whole slot in the other carriers or resource pools using the range or the RSRP measurement as the criteria. The distance threshold or the RSRP threshold may be dependent on the congestion level, which may be measured by the CBR or the resource exclusion threshold used in mode 2 autonomous resource selection procedure.

In some aspects, the UEs may use different radio access technologies (RATs) As one example, the UE may communicate using different RATs for sidelink communication. As another example, the UE may communicate using sidelink and DSRC. The different RATs may include NR V2X, long term evolution (LTE) V2X, and WiFi, and the sidelink communication using different RAT may be on the adjacent channels or on the same channel. In some aspects, the UE may exclude resources reserved for a sidelink transmission by another UE from potential resources for a transmission using another RAT. As an example, the resource reservation (e.g., from UE1 902) may be for NR V2X, and the UE2 904 may exclude the whole slot for potential transmissions using other RAT, such as LTE V2X. The exclusion may be based on any of the factors, conditions, or criteria described herein, such using a range or the RSRP. The distance threshold or the RSRP threshold may be dependent on the congestion level, which may be measured by the CBR or the resource exclusion threshold used in mode 2 autonomous resource selection procedure.

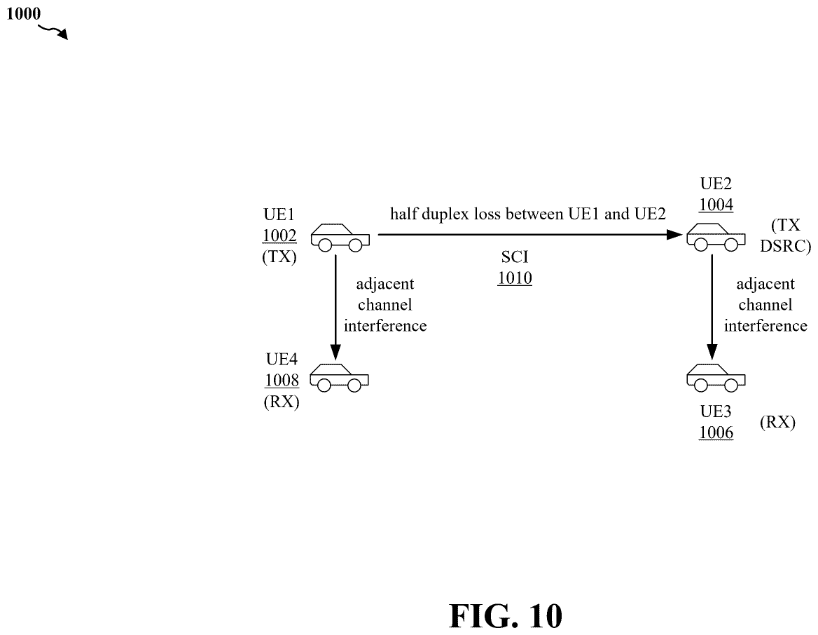

As another example, some vehicles may have a dual-model radio that may operate dedicated short range communication (DSRC) and NR V2X, e.g., at the same time. FIG. 10 is a diagram 1000 illustrating an example of resource selection and exclusion for sidelink communication in accordance with various aspects of the present disclosure. As shown in FIG. 10, in one instance, the first UE (UE1 1002) may be transmitting to the fourth UE (UE4 1008) using NR V2X communication, and the second UE (UE2 1004) may be transmitting to the third UE (UE3 1006) using DSRC. In that instance, the first UE (UE1 1002) may not receive the second UE (UE2 1004)'s DSRC communication due to half duplex, and the second UE (UE2 1004) may not receive the first UE (UE1 1002)'s NR V2X communication due to half duplex. Meanwhile, the third UE (UE2 1006) may not receive the first UE (UE1 1002)'s NR V2X communication due to adjacent channel interference, and the fourth UE (UE4 1008) may not receive the second UE (UE2 1004)'s DSRC communication due to half duplex. Hence, even if the first UE (UE1 1002) and the second UE (UE2 1004) may use different RAT for transmission, they may avoid transmitting at the same time to reduce interference.

For example, as shown in FIG. 10, when the first UE (UE1 1002) transmits SCI 1010 to the second UE (UE2 1004) at slot n using, for example, NR V2X communication. The SCI may indicate a sidelink transmission to the second UE (UE2 1004) at some slots. For example, the SCI may include a semi-persistent scheduling (SPS) periodicity, and, using the RSVP information (e.g., the SPS periodicity P), the second UE (UE2 1004) may expect similar sidelink transmission to arrive at slots n+P, n+2P, etc., where P is the SPS periodicity. Upon receiving the SCI, the second UE (UE2 1004) may decode the SCI and determine, based on the SCI (e.g., SCI-2), whether to accept or skip the sidelink communication at these slots (e.g., at slot n+P, n+2P). If the second UE (UE2 1004) accepted the sidelink communication, it may avoid selecting resources at these slots (e.g., slots n+P, n+2P) for transmission using a different RAT, such as DSRC. If some resources in these slots (e.g., slots n+P, n+2P) have already been selected, the second UE (UE2 1004) may reselect the resources that are not in these slots for communication. In some examples, even if the second UE (UE2 1004) does not accept the sidelink communication, it may still avoid selecting the resources at these slots (e.g., slots n+P, n+2P) for transmission using a different RAT if certain conditions (e.g., the RSRP and/or distance condition) are met.

The second UE (UE2 1004) may determine whether to accept or skip the sidelink transmission through various factors or criteria. In some aspects, the second UE (UE2 1004) may decode the SCI (e.g., SCI-1 and SCI-2) at slot n and obtain at least one of the SPS periodicity, zone information and the feedback distance, the RSRP measurement based on the SCI, and the L1 source and destination ID. The second UE (UE2 1004) may first determine whether it is the intended recipient of the sidelink communication based on the L1 source and destination ID. Then, if the zone information and the feedback distance is available, the second UE (UE2 1004) may determine whether to accept or skip the sidelink communication based on the zone information and the feedback distance D. In some examples, the second UE (UE2 1004) may set a distance threshold T_{D}, and the second UE (UE2 1004) may receive the sidelink transmission if the distance (e.g., the distance between UE1 1002 and UE2 1004) is smaller than a smaller value of the feedback distant D or the distance threshold T_{D} for slot level exclusion.

In some aspects, the distance threshold T_{D} may be related to the congestion level for the purpose of congestion control. In some examples, the congestion level may be measured by the CBR or the resource exclusion threshold used in mode 2 autonomous resource selection procedure. In one example, the congestion level may be represented by the CBR, and the distance threshold T_{D} may decrease as the CBR increases. Table 2 shows example distance thresholds T_{D} at different CBRs.

In some aspects, the distance threshold T_{D} may be related to the priority of the sidelink transmission, which may be included in SCI-1. For example, the distance threshold T_{D} for a higher priority transmission may be longer than the distance threshold T_{D} for a lower priority transmission.

In some aspects, the distance threshold T_{D} may be related to the cast type of the sidelink transmission. The cast type may include unicast, groupcast, or broadcast. For example, the distance threshold T_{D} for a unicast transmission may be longer than the distance threshold T_{D} for groupcast or broadcast transmissions.

In some aspects, the zone information and the feedback distance may not be available to the second UE (UE2 1004) (e.g., when the feedback distance is not used). In that case, the second UE (UE2 1004) may measure the RSRP based on the SCI, and compare the RSRP measurement with an RSRP threshold T_{RSRP} for slot level exclusion The second UE (UE2 1004) may accept the sidelink transmission if the measured RSRP is higher than the RSRP threshold T_{RSRP}. In some examples, the RSRP threshold T_{RSRP} may be related to the congestion level for the purpose of congestion control. The congestion level may be measured by the CBR or the resource exclusion threshold used in mode 2 autonomous resource selection procedure. In one example, the congestion level may be measured by the CBR, and the RSRP threshold T_{RSRP} may increase as the CBR increases. Table 3 shows example RSRP thresholds T_{RSRP} at different CBRs.

If the second UE (UE2 1004) decides to accept the sidelink transmission, it may exclude the slots (e.g., slots n+P, n+2P) for the sidelink transmission in its resource selection or reselection procedures using another RAT, such as DSRC. For example, the second UE (UE2 1004) may pass the slots (e.g., slots n+P, n+2P) it needs to receive the NR V2X communication to its DSRC module, and the DSRC module may skip these slots for DSRC communication. For example, the DSRC module may delay its clear channel assessment (CCA) processes around these slots. In some aspects, the exclusion of the slots may not apply to the slots of retransmission signaled, for example, in the SCI-1.

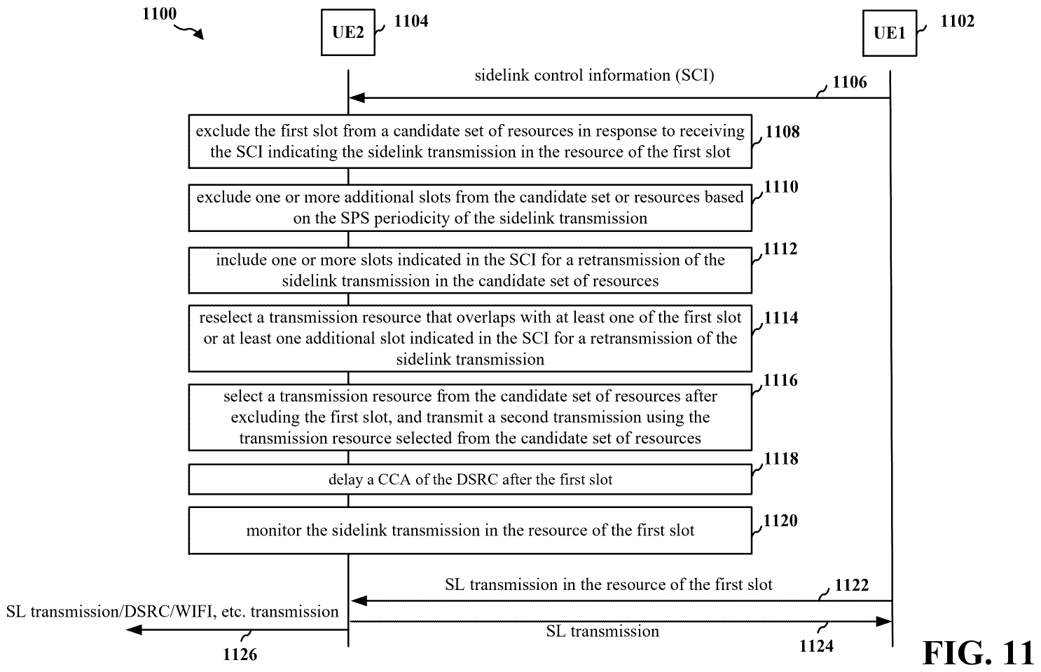

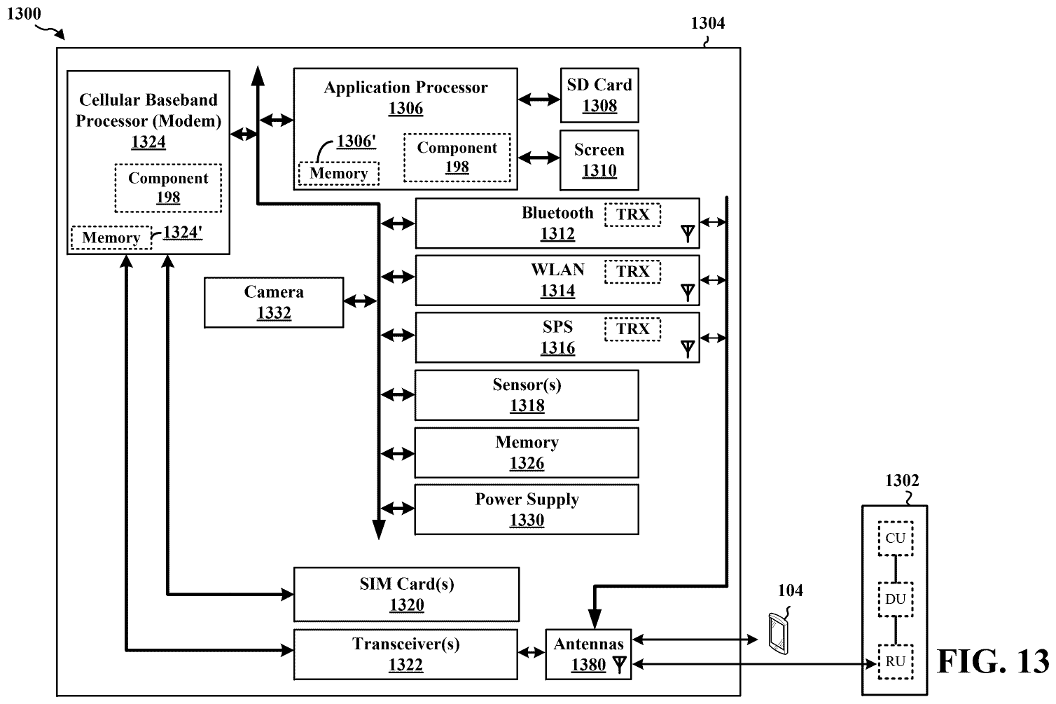

FIG. 11 is a call flow diagram 1100 illustrating a method of wireless communication in accordance with various aspects of this present disclosure. Aspects are described in connection with a first UE 1102 and a second UE 1104. The first UE 1102 may be device 350, UE 104, 902, 1002, or the apparatus 1304 in the hardware implementation of FIG. 13. The second UE 1104 may be device 350, UE 104, 904, 1004, or the apparatus 1304 in the hardware implementation of FIG. 13. In some examples, the first UE 1102 may also be referred to as an interfering UE, and the second UE 1104 may also be referred to as an interfered UE.

As shown in FIG. 11, at 1106, the first UE 1102 may transmit SCI to the second UE 1104. The SCI may indicate a sidelink transmission in a resource of a slot (e.g., a first slot). For example, referring to FIG. 9, the first UE 902 may transmit SCI 910 to the second UE 904. Referring to FIG. 10, the first UE 1002 may transmit SCI 1010 to the second UE 1004.

At 1108, in response to receiving the SCI, the second UE 1104 may exclude the first slot from a candidate set of resources. For example, referring to FIG. 9, the second UE 904 may exclude the first slot from a candidate set of resources for communication with the third UE 906. Referring to FIG. 10, the second UE 1004 may exclude the first slot from a candidate set of resources for communication with the third UE 1006.

At 1110, the second UE 1104 may exclude one or more additional slots from the candidate set of resources based on the SPS periodicity of the sidelink transmission. For example, if the SCI may include an SPS periodicity of P for the sidelink transmission, the second UE 1104 may exclude slots n+P, n+2P, n+3P, etc., from the candidate set of resources (slot n is the slot in which the second UE 1104 received the SCI).

At 1112, the second UE 1104 may include one or more slots indicated in the SCI for a retransmission of the sidelink transmission in the candidate set of resources. For example, if the SCI includes an SPS periodicity of P for the sidelink transmission, and the SCI further indicates that slot n+P is for a retransmission, the second UE 1104 may include slot n+P in the candidate set of resources.

At 1114, the second UE 1104 may reselect a transmission resource that overlaps with at least one of the first slot or at least one second slot indicated in the SCI for a retransmission of the sidelink transmission. For example, if the SCI indicates a sidelink transmission in slot n+P, and the second UE 1104 already selected slot n+P for another transmission, the second UE 1104 may reselect another slot for another transmission.

At 1116, the second UE 1104 may select a transmission resource from the candidate set of resources after excluding the first slot; and transmit a second transmission using the transmission resource selected from the candidate set of resources. For example, referring to FIG. 9, the first slot may be slot n+P, and the second UE 904 may select a transmission resource from the candidate set of resources after excluding the first slot (slot n+P), and transmit a second transmission using (e.g., to the third UE 906) the transmission resource selected from the candidate set of resources.

At 1118, the second UE 1104 may delay a CCA of the DSRC after the first slot. For example, referring to FIG. 10, after receiving the SCI from the first UE 1002 indicating a sidelink transmission using NR V2X communication at the first slot (e.g., slot n+P), the second UE 1004 may delay a CCA of the DSRC after the first slot (slot n+P).

At 1120, the second UE 1104 may monitor the sidelink transmission in the resource of the first slot. For example, referring to FIG. 9, the second UE 904 may monitor the sidelink transmission from the first UE 902, for example, in the resource of the first slot (e.g., slot n+P).

At 1122, the second UE 1104 may receive, from the first UE 1102, the sidelink transmission in the resource of the first slot. For example, referring to FIG. 9, the second UE 904 may receive, from the first UE 902, the sidelink transmission in the resource of the first slot (e.g., slot n+P).

At 1124 and/or 1126, the second UE 1104 may transmit using resources after excluding, at the slot level, based on the sidelink transmission from the first UE 1102. For example, the second UE 1104 may transmit a sidelink transmission 1124 to the first UE 1102 or a sidelink transmission 1126 to another UE. In some aspects, the transmission 1126 may be for a different RAT than the sidelink transmission from the first UE 1102. For example, the first UE 1102 may transmit an NR V2X transmission, and the transmission 1124 or 1126 may be for LTE V2X. In some aspects, the transmission from the first UE 1102 may be for sidelink (e.g., NR or LTE sidelink), and the transmission 1126 may be for DSRC, WiFi, etc.

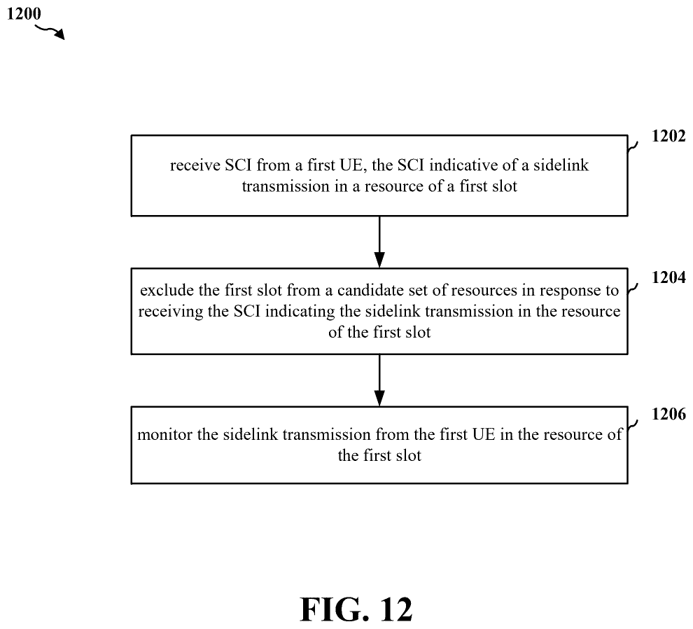

FIG. 12 is a flowchart 1200 illustrating methods of wireless communication at a second UE in accordance with various aspects of the present disclosure. The method may be performed by the second UE. The second UE may be device 350, UE 104, 904, 1004, 1104, or the apparatus 1304 in the hardware implementation of FIG. 13. The method enables a UE to manage the transmission resource for a sidelink transmission on the slot level based on various characteristics of the sidelink transmission. The method reduces the inter-UE interference and improves the efficiency of wireless communication.

As shown in FIG. 12, at 1202, the second UE may receive sidelink control information (SCI) from a first UE, the SCI indicative of a sidelink transmission in a resource of a first slot. The second UE may be device 350, UE 104, 804, 904, 1004, 1104, or the apparatus 1304 in the hardware implementation of FIG. 13. FIGS. 9, 10, and 11 illustrate various aspects of the steps in connection with flowchart 1200. For example, referring to FIG. 11, the second UE (UE 1104) may receive SCI from the first UE (UE 1102). The first UE may be UE 802, 902, 1002, 1102. The SCI may indicate a sidelink transmission in a resource of a slot (e.g., a first slot). Referring to FIG. 9, the second UE (UE 904) may receive SCI from the first UE (UE 902). Referring to FIG. 10, the second UE (UE 1004) may receive SCI from the first UE (UE 1002). In some aspects, 1202 may be performed by the SL resource management component 198.

At 1204, the second UE may exclude the first slot from a candidate set of resources in response to receiving the SCI indicating the sidelink transmission in the resource of the first slot. For example, referring to FIG. 11, in response to receiving the SCI, the second UE (UE 1104) may exclude the first slot from a candidate set of resources. For example, referring to FIG. 9, the second UE (UE 904) may exclude the first slot from a candidate set of resources for communication with the third UE 906. Referring to FIG. 10, the second UE (UE 1004) may exclude the first slot from a candidate set of resources for communication with the third UE 1006. In some aspects, 1204 may be performed by the SL resource management component 198.

At 1206, the second UE may monitor the sidelink transmission from the first UE in the resource of the first slot. For example, referring to FIG. 11, the second UE (UE 1104) may monitor, at 1120, to receive the sidelink transmission in the resource of the first slot. For example, referring to FIG. 9, the second UE (UE 904) may monitor the sidelink transmission from the first UE 902, for example, in the resource of the first slot. In some aspects, 1206 may be performed by the SL resource management component 198.

In some aspects, the SCI for the sidelink transmission may include one or more of: the SPS periodicity, the zone information and a feedback distance for the second UE, or the L1 source and destination ID. For example, referring to FIG. 11, the SCI the second UE (UE 1104) received, at 1106, from the first UE (UE 1102) may include one or more of: the SPS periodicity, the zone information and a feedback distance for the second UE, or the L1 source and destination ID.

In some aspects, the SCI may include the feedback distance, and the exclusion of the first slot from the candidate set of resources is based on a smaller value of the feedback distance or the distance threshold. For example, referring to FIG. 11, the SCI (UE 1104 received at 1106) may include the feedback distance, and the exclusion of the first slot from the candidate set of resources (at 1108) may be based on a smaller value of the feedback distance or the distance threshold.

In some aspects, the distance threshold may be based on one or more of: the congestion level, the priority of the sidelink transmission, or the cast type of the sidelink transmission. For example, referring to FIG. 11, the distance threshold (for excluding the first slot at 1108) may be based on one or more of: the congestion level, the priority of the sidelink transmission, or the cast type of the sidelink transmission.

In some aspects, the congestion level is based on at least one of: the CBR or a resource exclusion threshold for excluding individual resources from the candidate set of resources. For example, referring to FIG. 11, the congestion level (for excluding the first slot at 1108) may be based on at least one of: the CBR or a resource exclusion threshold for excluding individual resources from the candidate set of resources.

In some aspects, the distance threshold is based on the CBR of the channel between the second UE and the first UE. A first distance threshold corresponding to a first CBR is greater than a second distance threshold corresponding to a second CBR if the second CBR is greater than the first CBR. For example, referring to Table 2, A first distance threshold (e.g., T_{D}=1000 m) corresponding to a first CBR (e.g., 10%) may be greater than a second distance threshold (e.g., T_{D}=300 m) corresponding to a second CBR (e.g., 40%) if the second CBR (e.g., 40%) is greater than the first CBR (e.g., 10%).

In some aspects, the distance threshold is based on the priority of the sidelink transmission. A first distance threshold corresponding to a first priority is greater than a second distance threshold corresponding to a second priority if the first priority is higher than the second priority. For example, referring to FIG. 11, the distance threshold (for excluding the first slot at 1108) may be based on the priority of the sidelink transmission (from the UE 1102). A first distance threshold corresponding to a first priority may be greater than a second distance threshold corresponding to a second priority if the first priority is higher than the second priority.

In some aspects, the distance threshold is based on the cast type of the sidelink transmission, and the cast type includes one of: unicast, groupcast, or broadcast. A first distance threshold corresponding to the unicast is greater than a second distance threshold corresponding to the groupcast or the broadcast. For example, referring to FIG. 11, the distance threshold (for excluding the first slot at 1108) may be based on the cast type of the sidelink transmission (from the UE 1102). The cast type may include one of: unicast, groupcast, or broadcast, and a first distance threshold corresponding to the unicast is greater than a second distance threshold corresponding to the groupcast or the broadcast.

In some aspects, an exclusion of the first slot from the candidate set of resources is based on an RSRP measurement for the SCI being higher than an RSRP threshold. For example, referring to FIG. 11, the exclusion of the first slot from the candidate set of resources (at 1108) may be based on an RSRP measurement for the SCI being higher than an RSRP threshold.

In some aspects, the RSRP threshold may be based on a congestion level and is higher than a resource selection RSRP threshold for excluding individual resources within a slot from the candidate set of resources. For example, referring to FIG. 11, the RSRP threshold (for excluding the first slot at 1108) may be based on a congestion level and is higher than the resource selection RSRP threshold (used by UE 1104) for excluding individual resources within a slot from the candidate set of resources.

In some aspects, the RSRP threshold is based on a channel busy ratio (CBR) of a channel. A first RSRP threshold corresponding to a first CBR is greater than a second RSRP threshold corresponding to a second CBR if the second CBR is lower than the first CBR. For example, referring to Table 3, the RSRP threshold may be based on the CBR of a channel between the second UE and the first UE. A first RSRP threshold (e.g., 0 dBm) corresponding to a first CBR (e.g., 60%) may be greater than a second RSRP threshold (e.g.,-80 dBm) corresponding to a second CBR (e.g., 40%) if the second CBR (e.g., 40%) is lower than the first CBR (e.g., 60%).

In some aspects, the sidelink transmission may include an SPS periodicity, and the second UE may exclude one or more additional slots from the candidate set of resources based on the SPS periodicity of the sidelink transmission. For example, referring to FIG. 11, the second UE (UE 1104) may exclude, at 1110, one or more additional slots from the candidate set of resources based on the SPS periodicity of the sidelink transmission.

In some aspects, the second UE may further include one or more slots indicated in the SCI for a retransmission of the sidelink transmission in the candidate set of resources. For example, referring to FIG. 11, the second UE (UE 1104) may further include, at 1112, one or more slots indicated in the SCI for a retransmission of the sidelink transmission in the candidate set of resources.

In some aspects, the second UE may reselect a transmission resource that overlaps with at least one of the first slot or at least one second slot indicated in the SCI for a retransmission of the sidelink transmission. For example, referring to FIG. 11, the second UE (UE 1104) may reselect, at 1114, a transmission resource that overlaps with at least one of the first slot or at least one second slot indicated in the SCI for a retransmission of the sidelink transmission.

In some aspects, the sidelink transmission may be a first transmission, and the second UE may further select a transmission resource from the candidate set of resources after excluding the first slot; and transmit a second transmission using the transmission resource selected from the candidate set of resources. For example, referring to FIG. 11, the second UE (UE 1104) may, at 1116, select a transmission resource from the candidate set of resources after excluding the first slot, and transmit a second transmission using the transmission resource selected from the candidate set of resources. Referring to FIG. 9, the first slot may be slot n+P, and the second UE (UE 904) may select a transmission resource from the candidate set of resources after excluding the first slot (slot n+P), and transmit a second transmission using (e.g., to the third UE 906) the transmission resource selected from the candidate set of resources.

In some aspects, the second transmission may include a second sidelink transmission. For example, referring to FIG. 9, the second transmission may be a second sidelink transmission with third UE 906.

In some aspects, the first transmission may be for a first carrier in a CA configuration for the second UE, and, to exclude the first slot from the candidate set of resources, the second UE may: exclude the first slot from the candidate set of resources for a second carrier in the CA configuration for the second UE. For example, referring to FIG. 11, the first transmission (at 1106) may be for a first carrier in a CA configuration for the second UE (UE 1104), and, when excluding the first slot at 1108, the second UE (UE 1104) may exclude the first slot from the candidate set of resources for a second carrier in the CA configuration for the second UE (UE 1104).

In some aspects, the first transmission may be for a first sidelink resource pool, and, to exclude the first slot from the candidate set of resources, the second UE may exclude the first slot from the candidate set of resources for a second sidelink resource pool. For example, referring to FIG. 11, the first transmission (at 1106) may be for a first sidelink resource pool, and, to exclude the first slot from the candidate set of resources (at 1108), the second UE (UE 1104) may exclude the first slot from the candidate set of resources for a second sidelink resource pool.

In some aspects, the second transmission may be for a different radio access technology (RAT) than the sidelink transmission. For example, referring to FIG. 11, the second transmission (at 1116) may be for a different RAT than the sidelink transmission.

In some aspects, the sidelink transmission from the first UE may be an NR SL transmission, and the different RAT may include one of DSRC, LTE SL, or WiFi. For example, referring to FIG. 10, the sidelink transmission from the first UE (UE1 1002) may be the NR SL transmission, and the different RAT (for UE2 1004) may include one of DSRC, LTE SL, or WiFi.

In some aspects, the different RAT may be the DSRC, and the second UE may delay a CCA of the DSRC after the first slot. For example, referring to FIG. 11, when the different RAT is the DSRC, and the second UE (UE 1104) may, at 1118, delay a CCA of the DSRC after the first slot.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of device 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see device 350 of FIG. 3) and include the additional modules of the apparatus 1304.

As discussed supra, the component 198 may be configured to receive SCI from a first UE, the SCI indicative of a sidelink transmission in a resource of a first slot; exclude the first slot from a candidate set of resources in response to receiving the SCI indicating the sidelink transmission in the resource of the first slot; and monitor the sidelink transmission from the first UE in the resource of the first slot. The component 198 may be further configured to perform any of the aspects described in connection with the flowchart in FIG. 12, and/or performed by the UE 1104 in FIG. 11. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving SCI from a first UE, the SCI indicative of a sidelink transmission in a resource of a first slot, means for excluding the first slot from a candidate set of resources in response to receiving the SCI indicating the sidelink transmission in the resource of the first slot, and means for monitoring to receive the sidelink transmission from the first UE in the resource of the first slot. The apparatus 1304 may further include means for performing any of the aspects described in connection with the flowchart in FIG. 12, and/or aspects performed by the UE 1104 in FIG. 11. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

This disclosure provides a method for wireless communication at a UE. The method may include receiving SCI from a first UE, the SCI indicative of a sidelink transmission in a resource of a first slot; excluding the first slot from a candidate set of resources in response to receiving the SCI indicating the sidelink transmission in the resource of the first slot; and monitoring to receive the sidelink transmission from the first UE in the resource of the first slot. The method enables a UE to manage the transmission resource for a sidelink transmission on the slot level based on various characteristics of the sidelink transmission. The method reduces the inter-UE interference and improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a second UE. The method may include receiving SCI from a first UE, the SCI indicative of a sidelink transmission in a resource of a first slot; excluding the first slot from a candidate set of resources in response to receiving the SCI indicating the sidelink transmission in the resource of the first slot; and monitoring the sidelink transmission from the first UE in the resource of the first slot.

Aspect 2 is the method of aspect 1, where the SCI for the sidelink transmission may include one or more of: the SPS periodicity, zone information and a feedback distance for the first UE, an L1 source and destination ID, the cast type of the sidelink transmission, or the priority of the sidelink transmission.

Aspect 3 is the method of aspect 2, where excluding the first slot from the candidate set of resources may include excluding the first slot based on at least one of the L1 source and destination ID, the zone information and the feedback distance relative to a distance threshold, or an RSRP measured for the SCI.

Aspect 4 is the method of aspect 3, where the SCI may include the feedback distance, and the exclusion of the first slot from the candidate set of resources may be based on a smaller value of the feedback distance or the distance threshold.

Aspect 5 is the method of any of aspects 3 to 4, where the distance threshold may be based on one or more of: the congestion level, the priority of the sidelink transmission, or the cast type of the sidelink transmission.

Aspect 6 is the method of aspect 5, where the congestion level may be based on at least one of the CBR or a resource exclusion threshold for excluding individual resources from the candidate set of resources.

Aspect 7 is the method of aspect 6, where the distance threshold may be based on the CBR of the channel between the second UE and the first UE. A first distance threshold corresponding to a first CBR may be greater than a second distance threshold corresponding to a second CBR if the second CBR is greater than the first CBR.

Aspect 8 is the method of aspect 5, where the distance threshold may be based on the priority of the sidelink transmission. A first distance threshold corresponding to a first priority may be greater than a second distance threshold corresponding to a second priority if the first priority is higher than the second priority.

Aspect 9 is the method of aspect 5, where the distance threshold may be based on the cast type of the sidelink transmission. The cast type may include one of unicast, groupcast, or broadcast. A first distance threshold corresponding to the unicast may be greater than a second distance threshold corresponding to the groupcast or the broadcast.

Aspect 10 is the method of aspect 3, where the exclusion of the first slot from the candidate set of resources may be based on an RSRP measurement for the SCI being higher than an RSRP threshold.

Aspect 11 is the method of aspect 10, where the RSRP threshold may be based on one or more of the congestion level, the priority of the sidelink transmission, or the cast type of the sidelink transmission.

Aspect 12 is the method of aspect 11, where the congestion level may be based on at least one of the CBR), or a resource exclusion threshold for excluding individual resources from the candidate set of resources.

Aspect 13 is the method of aspect 12, where the RSRP threshold may be based on the CBR of a channel between the second UE and the first UE. A first RSRP threshold corresponding to a first CBR is greater than a second RSRP threshold corresponding to a second CBR if the second CBR is lower than the first CBR.

Aspect 14 is the method of aspect 11, where the RSRP threshold may be based on the priority of the sidelink transmission. A first RSRP threshold corresponding to a first priority may be lower than a second RSRP threshold corresponding to a second priority if the first priority is higher than the second priority.

Aspect 15 is the method of aspect 11, where the RSRP threshold may be based on the cast type of the sidelink transmission. The cast type may include one of unicast, groupcast, or broadcast. A first RSRP threshold corresponding to the unicast may be lower than a second RSRP threshold corresponding to the groupcast or the broadcast.

Aspect 16 is the method of aspect 11, where the RSRP threshold may be based on a congestion level and may be higher than a resource selection RSRP threshold for excluding individual resources within a slot from the candidate set of resources.

Aspect 17 is the method of any of aspects 1 to 16, where the sidelink transmission may include an SPS periodicity, and the method may further include excluding one or more additional slots from the candidate set of resources based on the SPS periodicity of the sidelink transmission.

Aspect 18 is the method of any of aspects 1 to 17, where the method may further include including one or more slots indicated in the SCI for a retransmission of the sidelink transmission in the candidate set of resources.

Aspect 19 is the method of any of aspects 1 to 18, where the method may further include reselecting a transmission resource that overlaps with at least one of the first slot or at least one second slot indicated in the SCI for a retransmission of the sidelink transmission.

Aspect 20 is the method of any of aspects 1 to 19, where the sidelink transmission may be a first transmission, and the method may further include: selecting a transmission resource from the candidate set of resources after excluding the first slot; and transmitting a second transmission using the transmission resource selected from the candidate set of resources.

Aspect 21 is the method of aspect 20, where the second transmission may include a second sidelink transmission.

Aspect 22 is the method of aspect 21, where the first transmission may be for a first carrier in a CA configuration for the second UE, and excluding the first slot from the candidate set of resources may include excluding the first slot from the candidate set of resources for a second carrier in the CA configuration for the second UE.

Aspect 23 is the method of aspect 20, where the first transmission may be for a first sidelink resource pool, and excluding the first slot from the candidate set of resources may include excluding the first slot from the candidate set of resources for a second sidelink resource pool.

Aspect 24 is the method of aspect 20, where the second transmission may be for a different RAT than the sidelink transmission.

Aspect 25 is the method of aspect 24, where the sidelink transmission from the first UE may be an NR SL transmission, and the different RAT may include one of: DSRC, LTE SL, or WiFi.

Aspect 26 is the method of aspect 25, where the different RAT may be the DSRC, and the method may further include: delaying a CCA of the DSRC after the first slot

Aspect 27 is an apparatus for wireless communication at a second UE, including: one or more memories; and at least one processor coupled to the one or more memories and, based at least in part on information stored in the one or more memories, the at least one processor is configured to perform the method of any of aspects 1-26.

Aspect 28 is the apparatus of aspect 27, further including at least one of a transceiver or an antenna coupled to the at least one processor and configured to receive the SCI from the first UE.

Aspect 29 is an apparatus for wireless communication including means for implementing the method of any of aspects 1-26.

Aspect 30 is a computer-readable medium (e.g., a non-transitory computer-readable medium) storing computer executable code, where the code when executed by a processor causes the processor to implement the method of any of aspects 1-26.

1. An apparatus for wireless communication at a second user equipment (UE), comprising:
one or more memories; and
at least one processor coupled to the one or more memories and, based at least in part on information stored in the one or more memories, the at least one processor is configured to:
receive sidelink control information (SCI) from a first UE, the SCI indicative of a sidelink transmission in a resource of a first slot;
exclude the first slot from a candidate set of resources in response to receiving the SCI indicating the sidelink transmission in the resource of the first slot; and
monitor the sidelink transmission from the first UE in the resource of the first slot.

2. The apparatus of claim 1, further comprising a transceiver coupled to the at least one processor, wherein, to receive the SCI, the at least one processor is configured to receive the SCI via the transceiver, and wherein the SCI for the sidelink transmission includes one or more of:
a semi-persistent scheduling (SPS) periodicity,
zone information and a feedback distance for the second UE,
a layer 1 (L1) source and destination identifier (ID),
a cast type of the sidelink transmission, or
a priority of the sidelink transmission.

3. The apparatus of claim 2, wherein, to exclude the first slot from the candidate set of resources, the at least one processor is configured to:
exclude the first slot based on at least one of:
the L1 source and destination ID,
the zone information and the feedback distance relative to a distance threshold, or
a reference signal received power (RSRP) measured for the SCI.

4. The apparatus of claim 3, wherein the SCI includes the feedback distance, and wherein an exclusion of the first slot from the candidate set of resources is based on a smaller value of the feedback distance or the distance threshold.

5. The apparatus of claim 4, wherein the distance threshold is based on one or more of:
a congestion level,
the priority of the sidelink transmission, or
the cast type of the sidelink transmission.

6. The apparatus of claim 5, wherein the congestion level is based on at least one of:
a channel busy ratio (CBR), or
a resource exclusion threshold for excluding individual resources from the candidate set of resources.

7. The apparatus of claim 6, wherein the distance threshold is based on the CBR of a channel between the second UE and the first UE, and wherein a first distance threshold corresponding to a first CBR is greater than a second distance threshold corresponding to a second CBR if the second CBR is greater than the first CBR.

8. The apparatus of claim 5, wherein the distance threshold is based on the priority of the sidelink transmission, and wherein a first distance threshold corresponding to a first priority is greater than a second distance threshold corresponding to a second priority if the first priority is higher than the second priority.

9. The apparatus of claim 5, wherein the distance threshold is based on the cast type of the sidelink transmission, and the cast type includes one of: unicast, groupcast, or broadcast, and wherein a first distance threshold corresponding to the unicast is greater than a second distance threshold corresponding to the groupcast or the broadcast.

10. The apparatus of claim 3, wherein an exclusion of the first slot from the candidate set of resources is based on an RSRP measurement for the SCI being higher than an RSRP threshold.

11. The apparatus of claim 10, wherein the RSRP threshold is based on one or more of:
a congestion level,
the priority of the sidelink transmission, or
the cast type of the sidelink transmission.

12. The apparatus of claim 11, wherein the congestion level is based on at least one of:
a channel busy ratio (CBR), or
a resource exclusion threshold for excluding individual resources from the candidate set of resources.

13. The apparatus of claim 12, wherein the RSRP threshold is based on the CBR of a channel between the second UE and the first UE, and wherein a first RSRP threshold corresponding to a first CBR is greater than a second RSRP threshold corresponding to a second CBR if the second CBR is lower than the first CBR.

14. The apparatus of claim 11, wherein the RSRP threshold is based on the priority of the sidelink transmission, and wherein a first RSRP threshold corresponding to a first priority is lower than a second RSRP threshold corresponding to a second priority if the first priority is higher than the second priority.

15. The apparatus of claim 11, wherein the RSRP threshold is based on the cast type of the sidelink transmission, and the cast type includes one of: unicast, groupcast, or broadcast, and wherein a first RSRP threshold corresponding to the unicast is lower than a second RSRP threshold corresponding to the groupcast or the broadcast.

16. The apparatus of claim 11, wherein the RSRP threshold is based on the congestion level and is higher than a resource selection RSRP threshold for excluding individual resources within a slot from the candidate set of resources.

17. The apparatus of claim 1, wherein the sidelink transmission includes a semi-persistent scheduling (SPS) periodicity, and wherein the at least one processor is further configured to:
exclude one or more additional slots from the candidate set of resources based on the SPS periodicity of the sidelink transmission.

18. The apparatus of claim 1, wherein the at least one processor is further configured to:
include one or more slots indicated in the SCI for a retransmission of the sidelink transmission in the candidate set of resources.

19. The apparatus of claim 1, wherein the at least one processor is further configured to:
reselect a transmission resource that overlaps with at least one of the first slot or at least one second slot indicated in the SCI for a retransmission of the sidelink transmission.

20. The apparatus of claim 1, wherein the sidelink transmission is a first transmission, and wherein the at least one processor is further configured to:
select a transmission resource from the candidate set of resources after excluding the first slot; and
transmit a second transmission using the transmission resource selected from the candidate set of resources.

21-30. (canceled)
